(19) United States
(12) Patent Application Publication
(10) Pub. No.: US 2026/0291005 A1
(43) Pub. Date: Sep. 24, 2026

(54) METHOD OF MANUFACTURING SEPARATOR FOR RECHARGEABLE BATTERY, SEPARATOR FOR RECHARGEABLE BATTERY, AND RECHARGEABLE BATTERY INCLUDING THE SAME

(71) Applicant: SAMSUNG SDI CO., LTD., Yongin-si (KR)

(72) Inventor: Kyoung Min KANG, Suwon-si (KR)

(73) Assignee: SAMSUNG SDI CO., LTD., Yongin-si (KR)

(21) Appl. No.: 19/569,007

(22) Filed: Mar. 17, 2026

(30) Foreign Application Priority Data
Mar. 18, 2025 (KR) 10-2025-0034323

(51) Int. Cl. H01M 50/403; H01M 50/417; H01M 50/449; H01M 50/491

(52) U.S. Cl. CPC H01M 50/403; H01M 50/417; H01M 50/449; H01M 50/491

(57) ABSTRACT

The present disclosure relates to a method of manufacturing a separator for a rechargeable battery, a separator for a rechargeable battery, and a rechargeable battery including the separator. The method includes manufacturing a porous film including a mixture of a polyolefin resin and a polyurethane resin. The porous film is manufactured by stretching a base film including the mixture of the polyolefin resin and the polyurethane resin to manufacture a stretched film and thermally compressing the stretched film. The polyurethane resin is included in the mixture in an amount in a range of about 15 wt % to about 60 wt %. The thermally compressing includes thermally compressing the stretched film to a range of about ½ to about ⅓ of its thickness at a temperature equal to or higher than a glass transition temperature of the polyurethane resin.

### CROSS-REFERENCE TO RELATED APPLICATION

The present application claims priority and the benefit of Korean Patent Application No. 10-2025-0034323, filed on Mar. 18, 2025 in the Korean Intellectual Property Office, the entire disclosure of which is incorporated herein by reference.

### BACKGROUND

### 1. Field of the Disclosure

The present disclosure relates to a method of manufacturing a separator for a rechargeable battery, a separator for a rechargeable battery, and a rechargeable battery including the separator.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of intercalation and deintercalation of lithium ions, and produces electric energy by oxidation and reduction reactions when the lithium ions are intercalated into, and deintercalated from, the positive electrode and the negative electrode. A rechargeable lithium battery may include a separator between the positive electrode and the negative electrode. A battery pack fire can start with the ignition of a single battery cell. A fire in a single battery cell can rapidly spread throughout the pack due to thermal runaway. The ignition of the battery cell is due to an internal short circuit between the positive electrode and the negative electrode. Therefore, when the internal short circuit can be terminated rapidly, the fire can be inhibited or prevented from growing.

### SUMMARY

One example embodiment is directed to providing a method of manufacturing a separator for a rechargeable battery capable of rapidly blocking internal short circuits between a positive electrode and a negative electrode.

Another example embodiment includes a separator for a rechargeable battery capable of rapidly blocking internal short circuits between a positive electrode and a negative electrode.

According to an aspect of the present disclosure, there is provided a method of manufacturing a separator for a rechargeable battery.

The method of manufacturing a separator includes manufacturing a porous film including a mixture of a polyolefin resin and a polyurethane resin. The porous film is manufactured by stretching a base film including the mixture of the polyolefin resin and the polyurethane resin to manufacture a stretched film and thermally compressing the stretched film. The polyurethane resin is included in the mixture in an amount in a range of about 15 wt % to about 60 wt %, and the thermally compressing includes thermally compressing the stretched film to a range of about ½ to about ⅓ of its thickness at a temperature equal to or higher than a glass transition temperature of the polyurethane resin.

According to another aspect of the present disclosure, a separator for a rechargeable battery includes a porous film including a mixture of a polyolefin resin and a polyurethane resin. The polyurethane resin is included in the mixture in an amount in a range of about 15 wt % to about 60 wt %, and the porous film has a thickness increase rate of about 60% or more according to the following Equation 1:

$$Thickness increase rate = ( T 4 - T 1 ) / T 1. \qquad Equation 1$$

In Equation 1,
T1 is a thickness of the porous film before heat treatment, and
T4 is a thickness of the porous film after heat treatment.

According to still another aspect of the present disclosure, there is provided a rechargeable battery.

The rechargeable battery includes a positive electrode, a negative electrode, and the separator for a rechargeable battery located between the positive electrode and the negative electrode.

### BRIEF DESCRIPTION OF THE DRAWINGS

The above and other objects, features and advantages of the present disclosure may be more apparent to those of ordinary skill in the art by describing example embodiments thereof in detail with reference to the accompanying drawings, in which:

FIG. 1 illustrates the operating principle of a separator for a rechargeable battery according to one example embodiment when exposed to heat;

FIG. 2 illustrates a thermal compression step in a method of manufacturing a separator for a rechargeable battery according to one example embodiment;

FIG. 3 to FIG. 6 are cross-sectional views schematically showing rechargeable lithium batteries according to example embodiments; and

FIG. 7 is a flowchart illustrating a method of manufacturing a separator for a rechargeable battery, according to an example embodiment.

### DETAILED DESCRIPTION

Hereinafter, example embodiments of the present disclosure are described in detail. However, the example embodiments are provided as examples, the present disclosure is not limited thereto, and the present disclosure is only defined by the scope of the claims to be described later.

Unless otherwise specified herein, when a part such as a layer, film, region, plate, and the like, is described as being “on” another part, it includes not only the case where the part is “directly on” the other part but also the case where there is another part present therebetween.

Unless otherwise specified in this specification, anything indicated in the singular may also include the plural. Further, unless otherwise stated, “A or B” may mean “including A, including B, or including A and B.”

As used herein, the term “a combination thereof” may mean a mixture, laminate, composite, copolymer, alloy, blend, and reaction product of the components.

Here, the term “particle diameter D50” refers to the average particle diameter, which means the diameter of particles with a cumulative volume of 50% by volume in the particle size distribution. The particle size distribution may be measured by methods known to those skilled in the art. For example, the particle size distribution may be measured using a particle size analyzer, a transmission electron micrograph, or a scanning electron micrograph. In another method, a D50 value may be obtained by measuring the particle diameter using a measuring device using, e.g., dynamic light scattering, performing data analysis to count the number of particles for each particle size range, and then calculating the particle diameter therefrom. Alternatively, D50 may be measured using, e.g., a laser diffraction method. For example, when measuring by laser diffraction, after the particles to be measured are dispersed in a dispersion medium, the particles may be introduced into a commercially available laser diffraction particle diameter measuring device (e.g., Microtrac MT 3000) and irradiated with ultrasonic waves of about 28 kHz at an output of 60 W, and the D50 based on 50% by volume of the particle diameter distribution in the measurement device may be calculated.

According to one example embodiment, a separator for a rechargeable battery and a method of manufacturing a separator for a rechargeable battery are provided that can rapidly block an internal short circuit when an internal short circuit occurs between a positive electrode and a negative electrode in a rechargeable battery. The internal short circuit may be caused by contact between the positive electrode and the negative electrode due to, e.g., separator damage and lithium precipitation, and the like, but the present disclosure is not limited thereto.

The separator can interrupt the short circuit current by hindering or blocking the contact between the positive electrode and the negative electrode by increasing the thickness of the separator, for example the porous film, and expanding the porous film by heat exposure. Therefore, the separator may secure the safety of the battery cell against fire by rapidly blocking internal short circuits.

The above “heat exposure” may include exposure of the separator to heat generated by an internal short circuit in the battery.

When the terms “about” or “substantially” are used in this specification in connection with a numerical value, it is intended that the associated numerical value include a tolerance of 10% around the stated numerical value. When ranges are specified, the range includes all values therebetween such as increments of 0.1%.

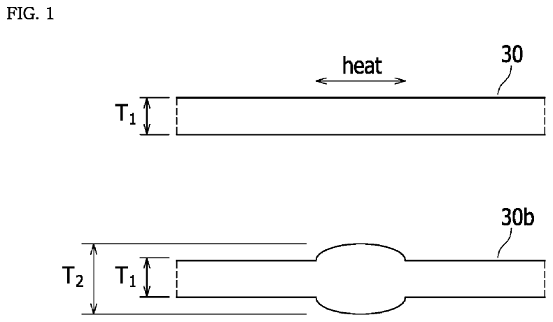

FIG. 1 illustrates the operating principle of a porous film in a separator for a rechargeable battery according to one example embodiment when exposed to heat.

Referring to FIG. 1, the porous film 30 has a thickness T1. However, when any portion of the porous film 30 is exposed to heat, the thickness of the portion of the porous film 30 exposed to heat is increased to a thickness T2, and thus the porous film 30 may be converted into a porous film 30b capable of hindering or blocking a short circuit current. Here, the heat generated by contact between the positive electrode and the negative electrode in a typical battery cell may be sufficient.

FIG. 1 illustrates the operating principle when a porous film is exposed to heat. However, the same may be applied when a laminate of a porous film and a coating layer is exposed to heat instead of the porous film.

According to one example embodiment, the separator includes a porous film, and the porous film has a thickness increase rate of 60% or more according to Equation 1 below. In the above range of thickness increase rate, internal short circuits may be sufficiently blocked by the thickness increase of the separator. For example, the thickness increase rate may be in a range of about 60% to about 150%, for example 60, 65, 70, 75, 80, 85, 90, 95, 100, 105, 110, 115, 120, 125, 130, 135, 140, 145, 150%.

$$Thickness increase rate = ( T 4 - T 1 ) / T 1. \qquad Equation 1$$

In Equation 1, T1 is a thickness of the porous film before heat exposure, and
T4 is a thickness of the porous film after heat exposure.

Here, in Equation 1, “heat exposure” means rapidly heating the entire porous film or a portion of the porous film from a range of about 60° C. to about 80° C. at a temperature increase rate in a range of about 10° C./min to about 20° C./min and then leaving the temperature at about 85° C. for about 60 seconds.

Here, when the entire porous film is experimentally exposed to heat, T4 in Equation 1 may be a maximum value among the thicknesses of the porous film. However, when only a portion of the porous film is heat treated, T4 in Equation 1 may be a maximum thickness of the porous film in the portion of the porous film that was heat treated.

Hereinafter, a method of manufacturing a separator for a rechargeable battery according to one example embodiment is described.

A method of manufacturing the separator for a rechargeable battery includes a step of manufacturing a porous film including a mixture of a polyolefin resin and a polyurethane resin, and the step of manufacturing the porous film includes a step of stretching a base film including the mixture of the polyolefin resin and the polyurethane resin to manufacture a stretched film and thermally compressing the stretched film to manufacture the porous film.

The mixture includes a polyolefin resin and a polyurethane resin.

In the present disclosure, in order to ensure that the porous film including the polyolefin resin has a thickness increase rate of about 60% or more according to Equation 1, the polyurethane resin is additionally included in the porous film. As is described below, the increase in the thickness of the separator may be achieved primarily by the step of thermally compressing the stretched film in the manufacturing method. The thermal compression is performed by melting and then compressing the resin included in the stretched film. The polyurethane resin can be advantageous in increasing the thickness of the above-described porous film or in achieving a thickness increase rate of 60% or more according to Equation 1. In addition, since the polyurethane resin may be substantially uniformly dispersed within the polyolefin resin, even when an internal short circuit occurs at any location between the positive electrode and the negative electrode, the internal short circuit can be rapidly blocked.

The polyurethane resin is included in the mixture in an amount in a range of about 15 wt % to about 60 wt %.

When the polyurethane resin is included in an amount less than about 15 wt % in the mixture, the stretched film may not be sufficiently compressed in the thermal compression, and thus the thickness increase rate by the heat treatment according to Equation 1 may be low. When the polyurethane resin is included in an amount more than about 60 wt % in the mixture, the polyurethane resin may be included in an excessive or substantial amount within the porous film, resulting in poor air permeability.

For example, the polyurethane resin may be included in the mixture in an amount in a range of about 15 wt % to about 55 wt %, for example, 25 wt % to 55 wt %, 30 wt % to 55 wt %, or 50 wt % to 55 wt %, for example 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59.60 wt %.

The thermal compression step includes thermally compressing the stretched film to a range of about ½ to about ⅓ of its thickness at a temperature that is equal to or higher than a glass transition temperature of the polyurethane resin.

In the thermal compression step, the polyurethane resin is melted and becomes liquid, thereby reducing the thickness of the stretched film to a predetermined or desired range. In the thermal compression step, the stretched film is compressed to in a range of about ½ to about ⅓ of its thickness, so that a thickness increase rate of 60% or more according to Equation 1 may be readily achieved.

Hereinafter, a method of manufacturing the porous film is described in detail.

### (1) A Base Film Including a Mixture of a Polyolefin Resin and a Polyurethane Resin is Stretched to Produce a Stretched Film.

A porous film including the mixture of a polyolefin resin and a polyurethane resin is manufactured by (1), wherein the polyurethane resin is included in an amount in a range of about 15 wt % to about 60 wt % in the mixture.

In one example embodiment, the polyolefin resin may include a polyolefin resin such as polyethylene or polypropylene. For example, the polyolefin resin may be or include a polypropylene resin.

In one example embodiment, the polyolefin resin may include a resin having a weight average molecular weight of about 1 million g/mol or less. A resin having a weight average molecular weight of about 1 million g/mol or less is easier to knead before extrusion and has a short heat setting time, which can improve the processability and productivity of manufacturing a porous substrate. In one example embodiment, the resin may have a weight average molecular weight in a range of about 600,000 g/mol to about 1,000,000 g/mol, for example from 500,000 to 800,000 g/mol or from 500,000 to 700,000 g/mol. Here, the weight average molecular weight is a value obtained as a polystyrene-converted value by gel permeation chromatography, and the units are g/mol.

In one example embodiment, the polyolefin resin may have a melting point in a range of about 120° C. to about 180° C., for example 120, 125, 130, 135, 140, 145, 150, 155, 160, 165, 170, 175, 180° C.

In one example embodiment, the polyolefin resin may include about 95 wt % or more, for example, a range of about 95 wt % to about 100 wt % or 100 wt %, of a polyolefin resin having a weight average molecular weight of about 1 million g/mol or less. In the above range, the properties of the porous substrate described above may be readily achieved.

In one example embodiment, the melting point of the polyolefin resin may be higher than the melting point of the polyurethane resin.

The polyurethane resin may be prepared by reacting one or more polyols with one or more polyisocyanate-based compounds. The polyurethane resin may be or include a random copolymer having units derived from the polyol.

The polyol may include one or more of a polyether polyol, a polyester polyol, a polyacrylic polyol, a polycaprolactone polyol, and a polycarbonate polyol. For example, the polyol may include one or more polyether polyols and may further include one or more polyester polyols.

The polyether polyol has an alkylene oxide group, and may for example include a polyether polyol having two or more hydroxyl groups, including a bifunctional polyether polyol (polyether diol) such as polyethylene glycol, polypropylene glycol, or polytetramethylene glycol, a trifunctional polyether polyol (polyether triol), or a trifunctional polyether polyol (polyether triol) of a glycerin alkylene oxide adduct.

The polyester polyol may include a polyester polyol having two or more hydroxyl groups, including one or more of a bifunctional polyester polyol (polyester diol) or a trifunctional polyester polyol (polyester triol). For example, a urethane binder becomes a hyper-branched binder, making it easier to implement the effects of the present disclosure. For example, a polyester diol may be used as the polyester polyol.

The polyisocyanate-based compound may include a polyisocyanate-based compound having multiple isocyanate groups (—NCO). The polyisocyanate-based compound may be or include a known polyisocyanate-based compound, and may include one or more of an aliphatic polyisocyanate, an alicyclic polyisocyanate, an aromatic polyisocyanate, and an aromatic aliphatic polyisocyanate. Among the above compounds, the aliphatic polyisocyanate may be preferred. The aliphatic polyisocyanate-based compound may include, but is not limited to, one or more of hexamethylene diisocyanate, trimethylene diisocyanate, tetramethylene diisocyanate, pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate.

The polyurethane resin may include a resin having a weight average molecular weight of about 500,000 g/mol or less, for example, in a range of about 100,000 g/mol to about 300,000 g/mol. In the above range, it is possible to readily manufacture a porous film satisfying Equation 1.

The polyurethane resin may have a glass transition temperature in a range of about 70° C. to about 100° C., for example, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100° C., 75 to 90° C. or 80 to 85° C. In the above range, it is possible to readily manufacture a porous film including a polyolefin resin having the above-described thickness increase rate by thermal compression.

A base film including a mixture of a polyolefin resin and a polyurethane resin is manufactured. The base film may be manufactured by a dry film-forming method or a wet film-forming method.

The resin mixture and a film-forming solvent are melt-kneaded to prepare a resin solution.

The resin may include the polyolefin resin and polyurethane resin. In addition, the resin solution may include various additives such as an oil, for example, at least one of liquid paraffin, an antioxidant, a heat stabilizer, an antistatic agent, an ultraviolet absorber, an antiblocking agent, a filler, a crystal nucleating agent, a crystallization retardant, and the like, within a range that does not impair the effects of the present disclosure.

The resin solution prepared above is fed from an extruder to a die and extruded into a sheet shape, and the obtained extruded molded body is cooled to manufacture an unstretched film, i.e., a casting film. The unstretched film may also be manufactured by feeding a plurality of resin solutions with the same or different compositions from a plurality of extruders to a single die, laminating the resin solutions therein, and extruding the resin solutions into a sheet shape.

In one example embodiment, a thickness of the unstretched film, i.e., the base film, may be in a range of about 4 times to about 9 times, for example 4, 5, 6, 7, 8, 9 times the thickness of the porous film. In the above range, mechanical strength and thermal expansion effects may be maximized.

In one example embodiment, a thickness of the unstretched film, i.e., the base film, may be about 50 μm or more, for example, 50, 55, 60, 65, 70, 75, 80, 85, 90, 95, 100, 105, 110, 115, 120, 125, 130, 135, 140, 145, 150 μm, in a range of about 50 μm to about 150 μm. In the above range, mechanical strength and thermal expansion effects may be maximized.

The base film is stretched to manufacture a stretched film.

The stretching may be for example performed such that a thickness of the final base film is about two times to about three times the thickness of the porous film. In the above range, it is possible to readily manufacture a porous film having a target thickness by thermal compression.

The stretching may include single-stage stretching or multi-stage stretching.

In one example embodiment, the stretching may be performed in a machine direction (MD) or the transverse direction (TD) of the base film. For example, the stretching may be performed uniaxially in the machine direction of the base film.

In the present specification, the machine direction of the base film may be the direction in which the unstretched film is manufactured when the base film is manufactured by melt extrusion or solution casting. In the present specification, the transverse direction of the base film may be a direction orthogonal to the machine direction.

In the above stretching, a stretching ratio may be for example in a range of about 2:1 to about 3:1. In the above range, a porous film having a desired thickness may be manufactured by the thickness of the base film and the thermal compression.

In the present specification, “stretching ratio” may mean a ratio of the length of the base film after stretching to the length of the base film before stretching.

Meanwhile, in the thermal compression step, the stretched film is compressed to a range of about ½ to about ⅓ of its thickness. Therefore, it may be desirable for the thickness of the stretched film to be in a range of about 2 times to about 3 times the thickness of the final porous film.

The stretching may be performed by, e.g., wet stretching.

In the above stretching, each stretching temperature may be adjusted according to the glass transition temperature of the polyolefin resin and the polyurethane resin. For example, the stretching temperature may be set to a range of about 90° C. to about 130° C. Subsequently, the film-forming solvent is removed from the base film after the stretching. The solvent may be removed by washing using a washing solvent. For example, the polyolefin phase of the resin is phase-separated from the film-forming solvent phase, so when the film-forming solvent is removed, a porous film is obtained, which is composed of or includes fibrils forming a fine three-dimensional network structure and has three-dimensionally irregularly interconnected holes (pores). Since the washing solvent and a method for removing the film-forming solvent using the washing solvent are known, the description of the washing solvent and of the method for removing the film-forming solvent is omitted.

### (2) the Stretched Film is Thermally Compressed to Manufacture the Porous Film.

In the thermal compression step, the stretched film is compressed at a temperature that is higher than the glass transition temperature of the polyurethane resin, and the stretched film is thermally compressed to in a range of about ½ to about ⅓ of its thickness.

In the thermal compression step, the thermal compression temperature is equal to or higher than the glass transition temperature of the polyurethane resin. In the above range, the thickness of the film can be reduced by the thermal compression by melting the polyurethane resin into a liquid state. For example, when the glass transition temperature of the polyurethane resin is T ° C., the thermal compression temperature may be in a range of about T ° C. to about (T+30) ° C. For example, the thermal compression temperature may be in a range of about 90° C. to about 150° C., for example 100 to 120° C. In the above range, it is easier to manufacture a porous film that satisfies the thickness increase rate of Equation 1 without increasing air permeability.

In the thermal compression step, the stretched film is compressed to a range of about ⅓ to about ½ of its thickness by thermal compression using a physical method.

In the thermal compression step, when the thickness of the stretched film is compressed at a ratio higher than about ½, since the thickness of the stretched film is excessively or substantially thermally compressed, even when heat is applied due to an internal short circuit of the cell, the volume expansion and thickness increase rates are small, so the short circuit current may not be properly blocked.

When the thickness of the stretched film is compressed at a ratio lower than about ⅓, the stretched film is less compressed, so even when heat is applied, the thickness increase rate is small and the short circuit current may not be properly blocked.

The thermal compression may be performed using a conventional thermal compression machine by compressing the stretched film at a predetermined or desired pressure while applying heat to the stretched film.

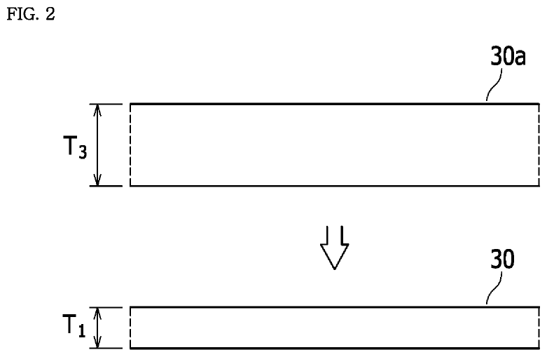

FIG. 2 illustrates a thermal compression step in a method of manufacturing a separator for a rechargeable battery according to one example embodiment. Referring to FIG. 2, a stretched film 30a before thermal compression has a thickness T3. By thermally compressing the stretched film 30a, a porous film 30 having a thickness T1 may be manufactured.

The method of manufacturing a porous film may further include a step of cooling the thermally compressed film after the thermal compression step.

The cooling step may fix the thickness of the porous film which thickness has been reduced by the thermal compression. The cooling is not particularly limited, but it may be desirable to proceed rapidly after the thermal compression.

In one example embodiment, a thickness of the first film may be in a range of about 5 μm to about 25 μm, for example 10 to 15 μm. In the above range, the separator may be located between the positive electrode and the negative electrode within the battery cell.

The method of manufacturing the separator for a rechargeable battery may further include a step of forming a coating layer on one or more surfaces of the porous film after manufacturing the porous film.

Since the coating layer is formed on one surface of the porous film, the coating layer may include any filler, binder, and the like, as long as the filler and/or binder does not affect the thickness increase rate of about 60% or more according to the above-described Equation 1.

In one example embodiment, the filler may be or include, for example, at least one of an inorganic filler, an organic filler, an organic-inorganic composite filler, or a combination thereof. The inorganic filler may be or include a ceramic material capable of improving heat resistance. The inorganic filler may include, for example, at least one of a metal oxide, a metalloid oxide, a metal fluoride, a metal hydroxide, or a combination thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic filler may include, but is not limited to, at least one of an acryl compound, an imide compound, an amide compound, or a combination thereof. The organic filler may have a core-shell structure, but is not limited thereto. For example, the filler may be or include boehmite.

The filler may be spherical, platy, cubic, or amorphous. The filler may have a particle diameter D50 of about 0.4 μm or less, for example, 0.3 μm or less, for example, in a range of about 0.2 μm to about 1.0 μm. In the above range, there may be an effect of improving the heat resistance of the separator.

The binder may be or include at least one of polyvinylidenefluoride-hexafluoropropylene (PVDF-HFP), polymethylmethacrylate (PMMA), polyvinylpyrrolidone (PVP), and the like.

Hereinafter, a separator for a rechargeable battery according to one example embodiment is described.

The separator for a rechargeable battery includes a porous film including a mixture of a polyolefin resin and a polyurethane resin, wherein the polyurethane resin is included in the mixture in an amount in a range of about 15 wt % to about 60 wt %, and the porous film has a thickness increase rate of about 60% or more according to the following Equation 1:

$$Thickness increase rate = ( T 4 - T 1 ) / T 1. \qquad Equation 1$$

In Equation 1,
T1 is a thickness of the porous film before heat treatment, and
T4 is a thickness of the porous film after heat treatment.

The porous film may be manufactured by the above-described method of manufacturing a porous film according to the example embodiment.

Since the polyolefin resin and the polyurethane resin are each described above, detailed descriptions thereof are omitted.

In one example embodiment, the separator for a rechargeable battery may be the porous substrate (film) alone.

In another example embodiment, the separator may include a porous substrate, and a coating layer including an organic material, an inorganic material, or a combination thereof located on one surface or both surfaces of the porous substrate.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be present as a mixture in one coating layer or present in a form in which a coating layer including an organic material and a coating layer including an inorganic material are stacked.

According to one example embodiment, the rechargeable lithium battery includes the separator for a rechargeable lithium battery; a positive electrode; and a negative electrode.

The separator for rechargeable lithium battery refers to the description described above. The separator for rechargeable lithium battery may be positioned between the positive electrode and the negative electrode.

A positive electrode for a rechargeable lithium battery may include a current collector and a positive electrode active material layer on the current collector. The positive electrode active material layer may include a positive electrode active material, and may further include a binder and/or a conductive material. For example, the positive electrode may further include an additive that can constitute a sacrificial positive electrode.

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂GbO₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃(0≤f≤2); or LiₐFePO₄(0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The positive electrode active material may be or include, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may independently be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause a chemical change (e.g., does not cause an undesirable chemical change in the rechargeable lithium battery), and that conducts electrons, can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in the form of a metal powder or a metal fiber; a conductive polymer such as a polyphenylene derivative; or a mixture thereof.

Al may be used as the current collector, but is not limited thereto.

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may also attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause a chemical change (e.g., does not cause an undesirable chemical change in the rechargeable lithium battery), and that conducts electrons, can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including copper, nickel, aluminum, silver, and the like, in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on the shape of the battery.

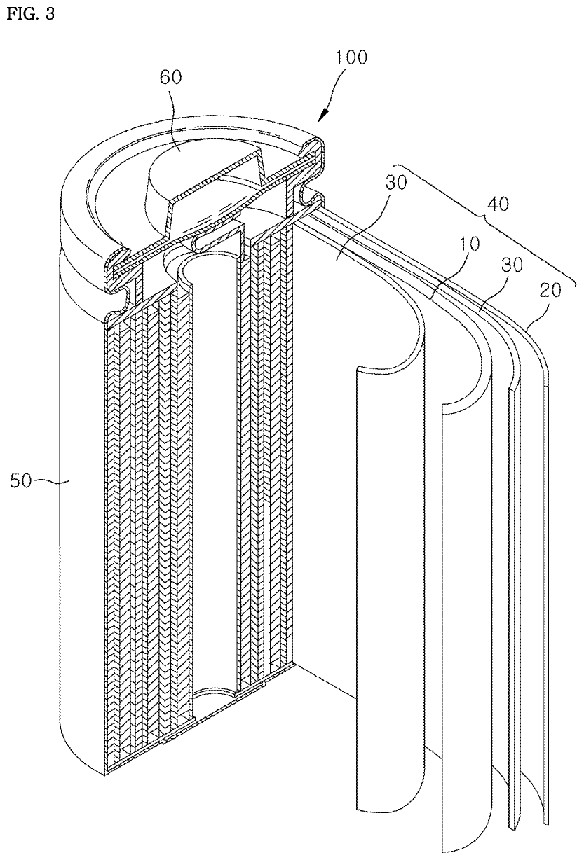

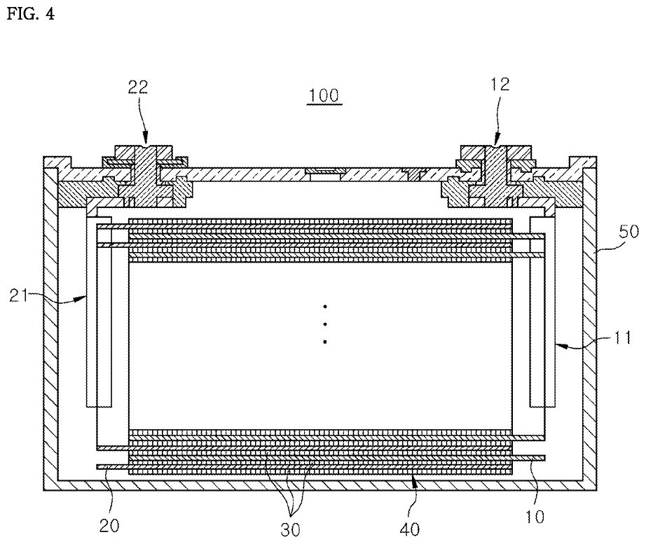

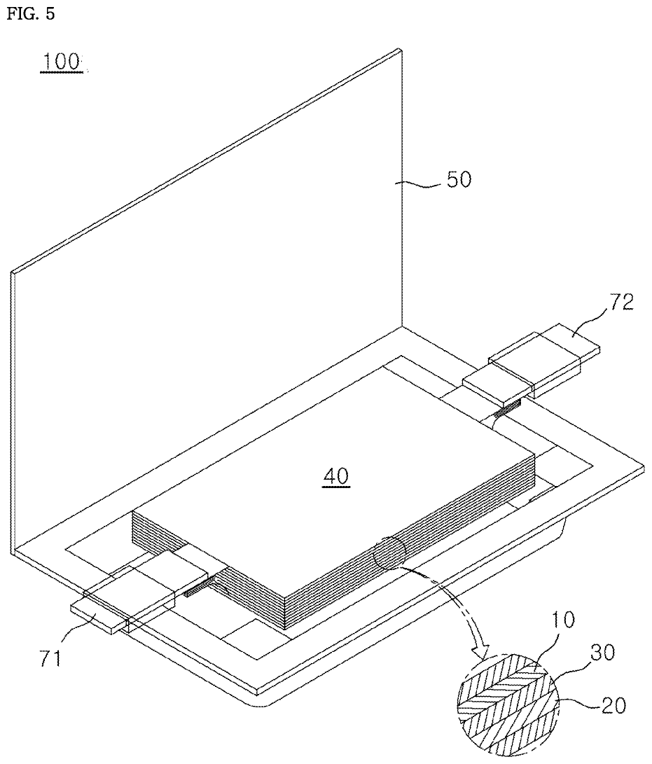

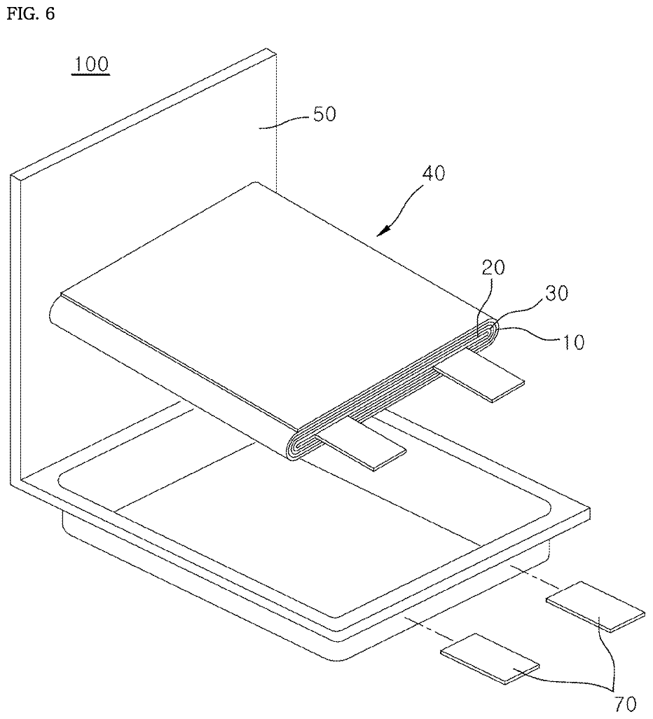

FIG. 3 to FIG. 6 are schematic views illustrating a rechargeable lithium battery according to an example embodiment. FIG. 3 shows a cylindrical battery, FIG. 4 shows a prismatic battery, and FIG. 5 and FIG. 6 show pouch-type batteries. Referring to FIG. 3 to FIG. 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 3. In FIG. 4, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 5 and FIG. 6, the rechargeable lithium battery 100 may include an electrode tab 70 illustrated in FIG. 6, or, for example, a positive electrode tab 71 and a negative electrode tab 72 illustrated in FIG. 5, the electrode tabs 70/71/72 forming an electric path for inducing the current formed in the electrode assembly 40 to the outside of the battery 100.

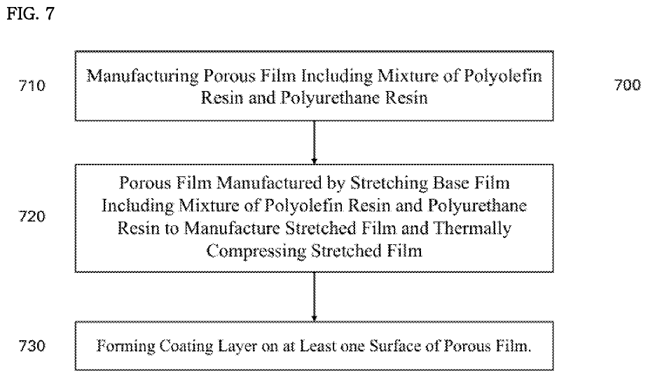

FIG. 7 is a flowchart illustrating a method of manufacturing a separator for a rechargeable battery, according to an example embodiment. In FIG. 7, the method 700 includes operation 710, which includes manufacturing a porous film including a mixture of a polyolefin resin and a polyurethane resin. For example, as indicated in operation 720, the porous film is manufactured by stretching a base film including the mixture of the polyolefin resin and the polyurethane resin to manufacture a stretched film and thermally compressing the stretched film. For example, the stretching is performed by stretching the base film so that a thickness of the base film is about two times to about three times a thickness of the porous film. In yet another example, the stretching is performed at a stretching ratio in a range of about 2:1 to about 3:1 in a machine direction of the base film. In another example, the polyurethane resin is included in the mixture in an amount in a range of about 15 wt % to about 60 wt %. In a further example, the thermally compressing includes thermally compressing the stretched film to a range of about ½ to about ⅓ of a thickness thereof at a temperature equal to or higher than a glass transition temperature of the polyurethane resin.

In other examples, the porous film has a thickness increase rate of about 60% or more according to Equation 1:

$$Thickness increase rate = ( T 4 - T 1 ) / T 1.$$

In Equation 1,
T1 is a thickness of the porous film before heat treatment, and
T4 is a thickness of the porous film after heat treatment.

In a further example, the polyolefin resin includes one or more of a polyethylene resin and a polypropylene resin. In yet another example, the polyolefin resin has a weight average molecular weight of about 1 million g/mol or less and a melting point in a range of about 120° C. to about 180° C. In yet another example, the polyurethane resin has a glass transition temperature in a range of about 70° C. to about 100° C. For example, a melting point of the polyolefin resin is higher than a melting point of the polyurethane resin. In a further example, when the glass transition temperature of the polyurethane resin in the thermal compression is T ° C., the thermal compression temperature is in a range about T ° C. to about (T+30) ° C. For example, the porous film has a thickness in a range of about 5 μm to about 25 km. In another example, a thickness of the base film is in a range of about 4 times to about 9 times a thickness of the porous film. In a further example, the method 700 further includes operation 730 which includes forming a coating layer on at least one surface of the porous film.

The rechargeable lithium battery according to an example embodiment may be applicable to, e.g., automobiles, mobile phones, and/or various types of electric devices, as non-limiting examples.

Hereinafter, examples and comparative examples of the present disclosure are described. However, the following examples are only examples of the present disclosure, and the present disclosure is not limited to the following examples.

### Example 1

100 parts by weight of a resin mixture including 70 parts by weight of a polyethylene resin (weight average molecular weight: 700,000 g/mol) and 30 parts by weight of a polyurethane resin (glass transition temperature: 80° C. and weight average molecular weight: 300,000 g/mol) was prepared. 100 parts by weight of the resin mixture was mixed with 72 parts by weight of liquid paraffin. Then, the resulting mixture was heated to 180 to 220° C., melted and kneaded, and mixed for 10 minutes.

The obtained solution was fed into a T die and extruded, and then the extruded molded body was cooled while being taken out by a cooling roll to manufacture a base film (thickness: 60 μm).

The manufactured base film was stretched uniaxially at a stretching ratio of 2:1 in the MD of the base film by wet stretching at 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 μm).

The stretched film was compressed to ½ of its thickness using a thermal compression machine at 140° C., which is a temperature equal to or higher than the glass transition temperature of the polyurethane resin to manufacture a porous film (thickness: 15 μm).

### Example 2

100 parts by weight of a resin mixture including 45 parts by weight of a polyethylene resin (weight average molecular weight: 700,000 g/mol) and 55 parts by weight of a polyurethane resin (glass transition temperature: 80° C. and weight average molecular weight: 300,000 g/mol) was prepared. 100 parts by weight of the resin mixture was mixed with 72 parts by weight of liquid paraffin. Then, the resulting mixture was heated to 180 to 220° C., melted and kneaded, and mixed for 10 minutes.

The obtained solution was fed into a T die and extruded, and then the extruded molded body was cooled while being taken out by a cooling roll to manufacture a base film (thickness: 60 μm).

The manufactured base film was stretched uniaxially at a stretching ratio of 2:1 in the MD of the base film by wet stretching at 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 μm).

The stretched film was compressed to ½ of its thickness using a thermal compression machine at 140° C., which is a temperature equal to or higher than the glass transition temperature of the polyurethane resin to manufacture a porous film (thickness: 15 μm).

### Example 3

In Example 1, 100 parts by weight of a resin mixture including 50 parts by weight of a polyethylene resin (weight average molecular weight: 700,000 g/mol) and 50 parts by weight of a polyurethane resin (glass transition temperature: 80° C. and weight average molecular weight: 300,000 g/mol) was prepared.

The obtained solution was fed into a T die and extruded, and then the extruded molded body was cooled while being taken out by a cooling roll to manufacture a base film (thickness: 60 km).

The manufactured base film was stretched uniaxially at a stretching ratio of 2:1 in the MD of the base film by wet stretching at 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 μm).

The stretched film was compressed to ⅓ of its thickness using a thermal compression machine at 140° C., which is a temperature equal to or higher than the glass transition temperature of the polyurethane resin to manufacture a porous film (thickness: 10 μm).

### Comparative Example 1

100 parts by weight of a polyethylene resin (weight average molecular weight: 700,000 g/mol) was mixed with 72 parts by weight of liquid paraffin. Then, the resulting mixture was heated to a range of 180° C. to 220° C., melted and kneaded, and mixed for 10 minutes.

The obtained solution was fed into a T die and extruded, and then the extruded molded body was cooled while being taken out by a cooling roll to manufacture a base film (thickness: 60 μm).

The manufactured base film was stretched uniaxially at a stretching ratio of 2:1 in the MD of the base film by wet stretching at a temperature in a range of 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 km).

The stretched film was compressed to ½ of its thickness using a thermal compression machine at 140° C. to manufacture a porous film (thickness: 15 km).

### Comparative Example 2

100 parts by weight of a resin mixture including 95 parts by weight of a polyethylene resin (weight average molecular weight: 700,000 g/mol) and 5 parts by weight of a polyurethane resin (glass transition temperature: 80° C. and weight average molecular weight: 300,000 g/mol) was prepared. 100 parts by weight of the resin mixture was mixed with 72 parts by weight of liquid paraffin. Then, the resulting mixture was heated to a temperature in a range of 180 C to 220° C., melted and kneaded, and mixed for 10 minutes.

The obtained solution was fed into a T die and extruded, and then the extruded molded body was cooled while being taken out by a cooling roll to manufacture a base film (thickness: 60 μm).

The manufactured base film was stretched uniaxially at a stretching ratio of 2:1 in the MD of the base film by wet stretching at a temperature in a range of 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 μm).

The stretched film was compressed to ½ of its thickness using a thermal compression machine at 140° C., which is a temperature equal to or higher than the glass transition temperature of the polyurethane resin to manufacture a porous film (thickness: 15 μm).

### Comparative Example 3

In Example 1, 100 parts by weight of a resin mixture including 90 parts by weight of a polyethylene resin (weight average molecular weight: 700,000 g/mol) and 10 parts by weight of a polyurethane resin (glass transition temperature: 80° C. and weight average molecular weight: 300,000 g/mol) was prepared.

The obtained solution was fed into a T die and extruded, and then the extruded molded body was cooled while being taken out by a cooling roll to manufacture a base film (thickness: 60 μm).

The manufactured base film was stretched uniaxially at a stretching ratio of 2:1 in the MD of the base film by wet stretching at a temperature in a range of 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 μm).

The stretched film was compressed to ½ of its thickness using a thermal compression machine at 140° C., which is a temperature equal to or higher than the glass transition temperature of the polyurethane resin to manufacture a porous film (thickness: 15 μm).

### Comparative Example 4

100 parts by weight of a resin mixture including 70 parts by weight of a polyethylene resin (weight average molecular weight: 700,000 g/mol) and 30 parts by weight of a polyurethane resin (glass transition temperature: 80° C. and weight average molecular weight: 300,000 g/mol) was prepared. 100 parts by weight of the resin mixture was mixed with 72 parts by weight of liquid paraffin. Then, the resulting mixture was heated to a temperature in a range of 180° C. to 220° C., melted and kneaded, and mixed for 10 minutes.

The obtained solution was fed into a T die and extruded, and then the extruded molded body was cooled while being taken out by a cooling roll to manufacture a base film (thickness: 60 μm).

The manufactured base film was stretched uniaxially at a stretching ratio of 2:1 in the MD of the base film by wet stretching at a temperature in a range of 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 μm).

### Comparative Example 5

100 parts by weight of a resin mixture including 70 parts by weight of a polyethylene resin (weight average molecular weight: 700,000 g/mol) and 30 parts by weight of a polyurethane resin (glass transition temperature: 80° C. and weight average molecular weight: 300,000 g/mol) was prepared. 100 parts by weight of the resin mixture was mixed with 72 parts by weight of liquid paraffin. Then, the resulting mixture was heated to a temperature in a range of 180° C. to 220° C., melted and kneaded, and mixed for 10 minutes.

The obtained solution was fed into a T die and extruded, and then the extruded molded body was cooled while being taken out by a cooling roll to manufacture a base film (thickness: 60 μm).

The manufactured base film was stretched uniaxially at a stretching ratio of 2:1 in the MD of the base film by wet stretching at a temperature in a range of 110° C. to 120° C. using a stretching machine to manufacture a stretched film (thickness: 30 μm).

Liquid paraffin was extracted and removed from the stretched film using methylene chloride, and the resulting stretched film was dried at room temperature to manufacture a porous stretched film (thickness: 30 μm).

The stretched film was compressed to ⅕ of its thickness using a thermal compression machine at 140° C., which is a temperature equal to or higher than the glass transition temperature of the polyurethane resin to manufacture a porous film (thickness: 6 μm).

The physical properties of the prepared porous film were evaluated, and the results are shown in Table 1 below.

Thickness increase rate (units: %): The thickness T1 of the porous films manufactured in the examples and comparative examples was measured. After the porous film was rapidly heated from 60° C. to 85° C. at a heating rate of 10° C./min to 20° C./min and then left at 85° C. for 60 seconds, the thickness T4 was measured. The thickness increase rate was measured using Equation 1.

Since the internal short circuit current blocking effect is determined by how much the thickness increases due to thermal expansion, the effect was evaluated as Low (thickness increase rate: 0% or more but less than 30%), Medium (thickness increase rate: 30% or more but less than 60%), and High (thickness increase rate: 60% or more) based on the thickness increase rate.

TABLE 1

| | Mixture | | | | Internal |
|---|---|---|---|---|---|
| | Poly- | Poly- | Pressing | | short |
| | ethylene | urethane | ratio | Thick- | circuit |
| | resin | resin | during | ness | current |
| | (parts by | (parts by | thermal | increase | blocking |
| | weight) | weight) | compression | rate (%) | effect |
| Example 1 | 70 | 30 | ½ | 60 | High |
| Example 2 | 45 | 55 | ½ | 110 | High |
| Example 3 | 50 | 50 | ⅓ | 70 | High |
| Comparative | 100 | 0 | ½ | 0 | Low |
| Example 1 | | | | | |
| Comparative | 95 | 5 | ½ | 10 | Low |
| Example 2 | | | | | |
| Comparative | 90 | 10 | ½ | 20 | Low |
| Example 3 | | | | | |
| Comparative | 70 | 30 | — | 0 | Low |
| Example 4 | | | | | |
| Comparative | 70 | 30 | ⅕ | 25 | Low |
| Example 5 | | | | | |

As shown in Table 1 above, the porous films of the examples had a thickness increase rate of 60% or more according to Equation 1. Therefore, it is expected that the porous films of the examples are able to rapidly block internal short circuits between the positive electrode and the negative electrode.

However, the porous films of the Comparative Examples had a thickness increase rate of less than 60% according to Equation 1 that was significantly lower than the thickness increase rate of the Examples. Therefore, it is expected that the porous films of the Comparative Examples may have a significantly lower internal short circuit blocking effect between the positive electrode and the negative electrode.

According to one example embodiment, when an internal short circuit occurs due to contact between the positive and negative electrodes within the battery cell due to separator damage or lithium precipitation, a separator for a rechargeable battery and a method of manufacturing a separator for a rechargeable battery can secure the safety of the battery cell against fire by increasing the thickness of the separator by heat exposure generated at the point where the short circuit occurs, thereby interrupting the short circuit current.

Although the example embodiments of the present disclosure have been described above, the present disclosure is not limited thereto, and various modifications may be made within the scope of the claims, the detailed description of the disclosure, and the attached drawings, which also fall within the scope of the present disclosure.

What is claimed is:

1. A method of manufacturing a separator for a rechargeable battery, the method comprising:
manufacturing a porous film including a mixture of a polyolefin resin and a polyurethane resin,
wherein the porous film is manufactured by stretching a base film including the mixture of the polyolefin resin and the polyurethane resin to manufacture a stretched film and thermally compressing the stretched film,
the polyurethane resin is included in the mixture in an amount in a range of about 15 wt % to about 60 wt %, and
the thermally compressing includes thermally compressing the stretched film to a range of about ½ to about ⅓ of a thickness thereof at a temperature equal to or higher than a glass transition temperature of the polyurethane resin.

2. The method of claim 1, wherein the porous film has a thickness increase rate of about 60% or more according to Equation 1:
$$Thickness increase rate = ( T 4 - T 1 ) / T 1 ; \qquad Equation 1$$
wherein:
T1 is a thickness of the porous film before heat treatment, and
T4 is a thickness of the porous film after heat treatment.

3. The method of claim 1, wherein the polyolefin resin includes one or more of a polyethylene resin and a polypropylene resin.

4. The method of claim 1, wherein the polyolefin resin has a weight average molecular weight of about 1 million g/mol or less, and a melting point in a range of about 120° C. to about 180° C.

5. The method of claim 1, wherein the polyurethane resin has a glass transition temperature in a range of about 70° C. to about 100° C.

6. The method of claim 1, wherein a melting point of the polyolefin resin is higher than a melting point of the polyurethane resin.

7. The method of claim 1, wherein the stretching is performed by stretching the base film so that a thickness of the base film is about two times to about three times a thickness of the porous film.

8. The method of claim 1, wherein the stretching is performed at a stretching ratio in a range of about 2:1 to about 3:1 in a machine direction of the base film.

9. The method of claim 1, wherein when the glass transition temperature of the polyurethane resin in the thermal compression is T ° C., the thermal compression temperature is in a range about T ° C. to about (T+30) ° C.

10. The method of claim 1, wherein the porous film has a thickness in a range of about 5 μm to about 25 μm.

11. The method of claim 1, wherein a thickness of the base film is in a range of about 4 times to about 9 times a thickness of the porous film.

12. The method of claim 1, further comprising forming a coating layer on at least one surface of the porous film.

13. A separator for a rechargeable battery, the separator comprising:
a porous film including a mixture of a polyolefin resin and a polyurethane resin;
wherein the polyurethane resin is included in the mixture in an amount in a range of about 15 wt % to about 60 wt %, and
the porous film has a thickness increase rate of about 60% or more according to Equation 1:
$$Thickness increase rate = ( T 4 - T 1 ) / T 1. ; \qquad Equation 1$$
wherein:
T1 is a thickness of the porous film before heat treatment, and
T4 is a thickness of the porous film after heat treatment.

14. The separator of claim 13, wherein a melting point of the polyolefin resin is higher than a melting point of the polyurethane resin.

15. The separator of claim 13, wherein the polyurethane resin has a glass transition temperature in a range of about 70° C. to about 100° C.

16. The separator of claim 13, wherein the polyolefin resin comprises a polyethylene resin.

17. The separator of claim 13, wherein the polyolefin resin has a weight average molecular weight of about 1 million g/mol or less, and a melting point in a range of about 120° C. to about 180° C.

18. The separator of claim 13, further comprising a coating layer formed on at least one surface of the porous film.

19. A rechargeable battery comprising the separator for a rechargeable battery of claim 13.
